(19) United States
(12) Patent Application Publication
(10) Pub. No.: US 2022/0398409 A1
(43) Pub. Date: Dec. 15, 2022

(54) CLASS PREDICTION BASED ON MULTIPLE ITEMS OF FEATURE DATA

(71) Applicant: Arm Limited, Cambridge (GB)

(72) Inventor: Emre OZER, Cambridge (GB)

(21) Appl. No.: 17/805,610

(22) Filed: Jun. 6, 2022

(30) Foreign Application Priority Data
Jun. 11, 2021 (GB) 2108398.5

(51) Int. Cl. G06K 9/62

(52) U.S. Cl. CPC G06K 9/6227; G06K 9/6256

(57) ABSTRACT

Apparatuses and methods for supporting class prediction based on multiple items of feature data are provided. Learning phase training data with known classification are used as inputs. Each event of the training data maps multiple items of feature data to encodings, where a range of values for each feature input are mapped to a given encoding. The concatenated encoding for the event form a joint feature item. Class counters are used to count class known to associated with the training event for the joint feature item in a table. At the conclusion of the training phase the class counter values enable a predicted class to be associated with each joint feature item in the table. In the inference phase the table is used for class prediction generation for new data events. The inference phase may be implemented in hardware which has less data handling capability than in the learning phase.

### CROSS-REFERENCE TO RELATED APPLICATIONS

This application claims priority pursuant to 35 U.S.C. 119(a) to United Kingdom Patent Application No. 2108398.5, filed Jun. 11, 2021, which application is incorporated herein by reference in its entirety.

### TECHNICAL FIELD

The present techniques relate to data processing. In particular the present techniques relate to generating a predicted class for an event represented by multiple items of feature data.

### SUMMARY

At least some examples provide a method comprising:
receiving multiple items of feature data for an event, where the multiple items of feature data are representative of a set of measurements taken for the event;
mapping each item of feature data to an encoding from a set of encodings, wherein a range of values for each feature input are mapped to the encoding;
concatenating multiple encodings corresponding to the multiple items of feature data for the event to generate a joint feature item;
operating a set of class counters, wherein each class counter corresponds to a class of a set of classes to which events can be assigned, and in response to the joint feature item generated in a training phase incrementing a class counter of the set of class counters corresponding to a known class associated with the event;
storing class counter values in joint feature membership table storage for each joint feature item generated in the training phase in which the multiple items of feature data are received for multiple training events;
calculating a membership value for each class of the set of classes in dependence on the class counter values in the joint feature membership table storage when the training phase is complete;
specifying a predicted class for each joint feature item in dependence on a largest membership value stored in the joint feature membership table storage for the joint feature item; and
storing in predicted class table storage an indication of the predicted class in association with each joint feature item in the joint feature membership table storage.

At least some examples provide a computer readable storage medium storing computer program instructions, which when executed on a computing device cause the computing device to carry out the above-mentioned method examples.

At least some examples provide an apparatus comprising:
multiple feature inputs configured to receive multiple items of feature data for an event, where the multiple items of feature data are representative of a set of measurements taken for the event;
mapping circuitry configured to map each item of feature data to an encoding from a set of encodings, wherein a range of values for each feature input are mapped to the encoding;
concatenation circuitry configured to concatenate multiple encodings corresponding to the multiple items of feature data for the event to generate a joint feature item;
class counter circuitry comprising a set of class counters, wherein each class counter corresponds to a class of a set of classes to which events can be assigned, and wherein the class counter circuitry is responsive to the joint feature item generated by the concatenation circuitry in a training phase to increment a class counter of the set of class counters corresponding to a known class associated with the event;
joint feature membership table storage configured to store class counter values for each joint feature item generated by the concatenation circuitry in the training phase in which the multiple feature inputs are configured to receive the multiple items of feature data for multiple training events;
predicted class definition circuitry configured to calculate a membership value for each class of the set of classes in dependence on the class counter values in the joint feature membership table storage when the training phase is complete and to specify a predicted class for each joint feature item in dependence on a largest membership value stored in the joint feature membership table storage for the joint feature item; and
predicted class table storage circuitry configured to store an indication of the predicted class in association with each joint feature item in the joint feature membership table storage.

At least some examples provide an apparatus comprising:
multiple feature inputs configured to receive multiple items of feature data for an event, where the multiple items of feature data are representative of a set of measurements taken for the event;
mapping circuitry configured to map each item of feature data to an encoding from a set of encodings, wherein a range of values for each feature input are mapped to the encoding;
concatenation circuitry configured to concatenate multiple encodings corresponding to the multiple items of feature data for the event to generate an event joint feature item;
predicted class table storage circuitry configured to store an indication of a predicted class in association with each joint feature item of a set of joint feature items, wherein the predicted class associated with each joint feature item was previously learned in a training process based on multiple training events with known classes,
wherein in the training process a class counter of a set of class counters corresponding to a known class associated with the training event was incremented for each training event to generate class counter values for each joint feature item generated by the concatenation circuitry in the training phase, and a membership value for each class of the set of classes was determined in dependence on the class counter values when the training process was complete, and predicted classes for the joint feature items were determined in dependence on a largest membership value determined for each joint feature item; and
predicted class output circuitry configured to output the predicted class for the event joint feature item in dependence on the predicted classes stored in the predicted class table storage circuitry.

At least some examples provide a method comprising:
receiving multiple items of feature data for an event, where the multiple items of feature data are representative of a set of measurements taken for the event;
mapping each item of feature data to an encoding from a set of encodings, wherein a range of values for each feature input are mapped to the encoding;
concatenating multiple encodings corresponding to the multiple items of feature data for the event to generate an event joint feature item;
storing in predicted class table storage an indication of a predicted class in association with each joint feature item of a set of joint feature items, wherein the predicted class associated with each joint feature item was previously learned in a training process based on multiple training events with known classes,
wherein in the training process a class counter of a set of class counters corresponding to a known class associated with the training event was incremented for each training event to generate class counter values for each joint feature item generated in the training phase, and a membership value for each class of the set of classes was determined in dependence on the class counter values when the training process was complete, and predicted classes for the joint feature items were determined in dependence on a largest membership value determined for each joint feature item; and
outputting the predicted class for the event joint feature item in dependence on the predicted classes stored in the predicted class table storage.

At least some examples provide a computer readable storage medium storing computer program instructions, which when executed on a computing device cause the computing device to carry out the above-mentioned method examples.

### BRIEF DESCRIPTION OF THE DRAWINGS

The present techniques will be described further, by way of example only, with reference to embodiments thereof as illustrated in the accompanying drawings, to be read in conjunction with the following description, in which:

FIG. 1 schematically illustrates class membership of a feature data item;

FIG. 2 schematically illustrates class membership of fuzzy regions of feature data values for a feature data item;

FIG. 3 schematically illustrates joint fuzzy feature construction and class membership based on multiple feature data items;

FIG. 4 schematically illustrates a sequence of steps taken in a training phase in some examples;

FIG. 5 schematically illustrates an apparatus for implementing a training phase in some examples;

FIG. 6 schematically illustrates a predicted class table being generated in a training phase and used in an inference phase in some examples;

FIG. 7A schematically illustrates joint fuzzy feature generation in some examples;

FIG. 7B schematically illustrates distance based encoding used in in some examples;

FIG. 8 schematically illustrates a joint fuzzy feature membership table in some examples;

FIG. 9 schematically illustrates a joint fuzzy feature prediction table in some examples;

FIG. 10 schematically illustrates a sequence of steps taken to reduce the size of a joint feature membership table in some examples;

FIG. 11 schematically illustrates a sequence of steps taken to reduce the size of a joint feature membership table in some examples;

FIG. 12 schematically illustrates a software based learning phase and a hardware based inference phase in some examples;

FIG. 13 schematically illustrates an apparatus for implementing an inference phase in some examples;

FIG. 14 schematically illustrates an apparatus for implementing an inference phase in some examples;

FIGS. 15, 16, and 17 show the resulting accuracy and table size for a range of number of fuzzy regions and a range of coalescing distance in some examples compared with conventional ML techniques for three respective datasets; and

FIG. 18 schematically illustrates a general purpose computer which may be used in some examples.

### DESCRIPTION

In examples herein there is method comprising:
receiving multiple items of feature data for an event, where the multiple items of feature data are representative of a set of measurements taken for the event;
mapping each item of feature data to an encoding from a set of encodings, wherein a range of values for each feature input are mapped to the encoding;
concatenating multiple encodings corresponding to the multiple items of feature data for the event to generate a joint feature item;
operating a set of class counters, wherein each class counter corresponds to a class of a set of classes to which events can be assigned, and in response to the joint feature item generated in a training phase incrementing a class counter of the set of class counters corresponding to a known class associated with the event;
storing class counter values in joint feature membership table storage for each joint feature item generated in the training phase in which the multiple items of feature data are received for multiple training events;
calculating a membership value for each class of the set of classes in dependence on the class counter values in the joint feature membership table storage when the training phase is complete;
specifying a predicted class for each joint feature item in dependence on a largest membership value stored in the joint feature membership table storage for the joint feature item; and
storing in predicted class table storage an indication of the predicted class in association with each joint feature item in the joint feature membership table storage.

It may be required in a number of contexts for a set of data to be classified. That is to say that multiple data items, which together form the set of data, may correspond to one of several classifications or classes. The set of data may be produced in a great range of contexts depending on which the set of data may have a great range of meanings. The present techniques are however not concerned with the context in which the set of data is produced or what the data represent. Accordingly the techniques presented herein are not limited in either of these regards. Whatever the context and meaning, generally speaking the task of the data processing apparatus here, when provided with a finite set of input data items, is to assign the set of data to one of a predetermined set of possible classifications or classes. The true or desired classification for a given set of input data is defined by the system designer and for a relatively limited multiplicity of input data items and a relatively limited multiplicity of classes this correspondence can in principle be exhaustively defined. Thus, referring to the set of data items as a set of “features”, if the entire population space of the feature combinations is known (i.e. all possible permutations) then class values for all future combinations can be stored (e.g. in a lookup table structure) which can then be referred to for any given set of feature values received in order to generate a corresponding class value indicative of a classification.

However as the multiplicity of the features (number of input data items), the range of values which those features may take, and the multiplicity of the possible classifications grow, the number of entries which would be required to be stored in such a lookup table becomes impractically large. Constraints on the size of a lookup table which it is practical to implement become even more restrictive in the context of hardware implementations with limited storage capacity (such as for the example may be the case for portable, low power devices such as may be provided as a system-on-chip). In this context the present techniques are proposed, which in part make use of “fuzzy logic” approaches. A fuzzy logic value is different from Boolean logic (0 or 1) in that it is a variable representation ranging from 0 to 1 representing a degree of truth between those extremes. A fuzzy membership function assigns a value between 0 and 1 to a possible value for a feature (also referred to as a “member” of the set of possible value), denoting its membership degree to the underlying fuzzy set.

For the purposes of a hardware implementation of the present techniques, each possible class can be viewed as a fuzzy set in which all possible values of a feature are the fuzzy set members with some membership degree. For example, all possible values may be defined as all integer values in an n-bit integer value of the feature, such that, if the feature is a signed 8-bit integer, then all possible values in the set are within the range [−128, +127]. Each number within [−128, +127] becomes a member, and its membership value per class or fuzzy set can be calculated. Multiple features characterise the “event” to be classified, where it is to be understood that an “event” may correspond to a discrete occurrence for which feature data are captured, or may merely correspond to the “snapshot” of feature data which are captured at an arbitrary point in time of quantities that may (at least in principle) continuously vary with time. Thus this is an example of receiving multiple items of feature data for an event, where the multiple items of feature data are representative of a set of measurements taken for the event.

Accordingly, for a data processing implementation of this approach, the membership function for each feature can be computed using a set of training data. In the training dataset, all training data are visited to compute the membership functions. During this process, a counter-per-class can be assigned to each member of a feature. The counter-per-class of the member value is then incremented by one every time the feature takes that member value and the label of the data-point determining the class or fuzzy set in a training data-point. After all training data-points are visited, there is a counter-per-class value for each member in a feature. To compute the membership value between 0 and 1 per fuzzy set for each member in a feature, its counter-per-class value can be divided by the sum of all the counter-per-class values.

The present techniques extend this approach further, based on the realisation that although each feature value can be considered as a fuzzy set member, a group of features values can also be considered as a member. Hence here the entire data range of the feature can be divided into regions or fuzzy regions. Each fuzzy region contains affine values that represent the same member, i.e. each fuzzy region is a proxy to represent all the numbers within the region. Hence instead of finding a membership value for each distinct feature value, the present techniques propose that the membership of a fuzzy region is extended to fuzzy regions. Thus for a feature for which the possible values cover the range [−2ⁿ⁻¹, 2ⁿ⁻¹−1], a first region may be defined comprising all feature values in the range [−2ⁿ⁻¹, −2ⁿ⁻¹+r], a second region may be defined comprising all feature values in the range [−2ⁿ⁻¹+r+1, −2ⁿ⁻¹+r+s], and so on, up to a last region comprising all feature values in a final group extending up to [+2ⁿ⁻¹−1]. These regions may be arbitrarily labelled (by the system designer) since this has no bearing on the present techniques and thus could for example, be called “VERY LOW”, “LOW”, etc. up to “VERY HIGH”.

Using the training data, the membership of each fuzzy region in a feature to each class or fuzzy set can be computed in a similar manner as the individual feature values described above. What is important here is the joint membership relationships across multiple features that will determine the performance of the predictor. As each feature value is mapped to a fuzzy region, computing the joint memberships is tractable because of much fewer fuzzy values or regions. Using the training data, the joint membership of all features can be easily calculated in a manageable table size. Joint fuzzy memberships are calculated on the basis of the counts of the joint fuzzy regions from the training data.

The approach taken by the present techniques for introducing the “fuzzy” representation of the feature data is for multiple regions to be defined for each feature, with the multiple regions together spanning the full range of possible values for that feature. Each region is then mapped to a unique encoding which is used further as is described in more detail below. Thus, this is an example of mapping each item of feature data to an encoding from a set of encodings, wherein a range of values for each feature input are mapped to the encoding. Thus mapped to the encodings, a “joint fuzzy feature” is formed by concatenating the multiple encodings to which the feature data have been mapped. This is thus an example of concatenating multiple encodings corresponding to the multiple items of feature data for the event to generate a joint feature item. These concatenated entries are then stored in a table structure associated with a set of corresponding per-class counters. With the joint feature items thus prepared a learning phase making use of training data can then be followed through, according to which each training data point is converted into a joint fuzzy feature (set of concatenated encodings) and its true class label is used to identify the class identifier in the entry and the counter for that class is incremented. This is thus firstly an example of operating a set of class counters, wherein each class counter corresponds to a class of a set of classes to which events can be assigned, and in response to the joint feature item generated in a training phase incrementing a class counter of the set of class counters corresponding to a known class associated with the event. Secondly this is an example of storing class counter values in joint feature membership table storage for each joint feature item generated in the training phase in which the multiple items of feature data are received for multiple training events.

After all training data points are visited, the joint membership values are calculated from the counters, and the class with the maximum membership value is the predicted class for the joint fuzzy feature. The joint fuzzy feature membership table is reduced to a final prediction table. This is thus an example of calculating a membership value for each class of the set of classes in dependence on the class counter values in the joint feature membership table storage when the training phase is complete; then specifying a predicted class for each joint feature item in dependence on a largest membership value stored in the joint feature membership table storage for the joint feature item; and finally storing in predicted class table storage an indication of the predicted class in association with each joint feature item in the joint feature membership table storage.

The set of encodings used may be variously chosen, but in some embodiments the set of encodings is a distance-based set of encodings, wherein a difference between two encodings of the set of encodings reflects a difference between two respective feature regions to which the two encodings correspond. The distance-based encoding may be variously implemented, but in some embodiments the set of encodings is a Hamming distance-based set of encodings.

The present techniques propose a further technique to reduce storage requirements of the predicted class table storage and the joint feature membership table storage. In some embodiments the method further comprises performing an entry coalescing process comprising sorting entries in the joint feature membership table storage in dependence on a sum of the class counter values for each joint feature item and coalescing entries which have a same predicted class in dependence on the difference between their encodings. The sorting of the entries in dependence on the sum of the class counter values per joint feature item means that the more significant entries in these tables can be prioritised. Coalescing entries with the same predicted class based on encoding differences then enables the class prediction tables to be of smaller size, but without significantly losing prediction accuracy.

In some embodiments coalescing the entries comprises retaining a dominant entry with a larger sum of the class counter values, discarding one or more recessive entries with a smaller sum of the class counter values, and transferring the class counter values from the one or more recessive entries to the dominant entry. This enables the resulting coalesced entries to maintain the class counter values which have been built up, by allocation from recessive, i.e. less significant entries (on the basis of their own individual class counter sum), to dominant entries, i.e. more significant entries (on the basis of their own individual class counter sum). Thus, the counter values of the recessive entries are accumulated with the counter values of the coalesced entry (i.e. the dominant entry).

The entry coalescing process may be performed in a variety of ways and to a variety of extents, that is to say more or fewer entries might be coalesced. The present techniques recognise that the extent of the entry coalescing process can be flexibly defined, allowing a trade-off to be chosen by a given implementation between a smaller storage requirement resulting from more coalescing and a high prediction accuracy resulting from less coalescing. Thus in some embodiments the entry coalescing process is performed as an encoding-distance limited process according to which the entry coalescing process is performed for differences between encodings which differ by up to a predetermined encoding distance threshold.

The predetermined distance threshold may be set in a variety of ways but in some embodiments the predetermined encoding distance threshold is determined prior to the method being performed by a parameter exploration process, which tests the entry coalescing process for all possible differences between encodings. This provides an opportunity to determine an optimal (or at least satisfactory) balance between the storage requirement for the tables and the resulting prediction accuracy. Thus in some embodiments the predetermined encoding distance threshold is selected as a result of the parameter exploration process dependent on a resulting size of the joint feature membership table storage and a corresponding accuracy of the predicted class.

The present techniques have further identified that when coalescing entries it can be useful to identify bits in the respective entries which do/do not differ from one another. In particular further advantage may be gained when implementing these techniques by identifying those bits which differ between a main entry and one which is removed by merging with the main entry. The advantage comes when subsequently using the results of the method, such as in a hardware implementation of a device to make class predictions which comprises hardwired comparators to compare joint feature items, since then comparators (e.g. XOR comparators) corresponding to those bits (also referred to herein as “don't care bits”) can be eliminated. Thus in some embodiments the method further comprises determining at least one bit position of bits which differ between the dominant entry and the one or more recessive entries and storing the at least one bit position in association with the dominant entry in the joint feature membership table storage, wherein any positions previously stored in association with the one or more recessive entries are transferred to the dominant entry.

The above described methods maybe implemented in a variety of ways but in some examples there is provided a computer readable storage medium storing computer program instructions, which when executed on a computing device cause the computing device to carry out the method in any of the forms outlined above.

There may also be provided an apparatus comprising:
multiple feature inputs configured to receive multiple items of feature data for an event, where the multiple items of feature data are representative of a set of measurements taken for the event;
mapping circuitry configured to map each item of feature data to an encoding from a set of encodings, wherein a range of values for each feature input are mapped to the encoding;
concatenation circuitry configured to concatenate multiple encodings corresponding to the multiple items of feature data for the event to generate a joint feature item;
class counter circuitry comprising a set of class counters, wherein each class counter corresponds to a class of a set of classes to which events can be assigned, and wherein the class counter circuitry is responsive to the joint feature item generated by the concatenation circuitry in a training phase to increment a class counter of the set of class counters corresponding to a known class associated with the event;
joint feature membership table storage configured to store class counter values for each joint feature item generated by the concatenation circuitry in the training phase in which the multiple feature inputs are configured to receive the multiple items of feature data for multiple training events;
predicted class definition circuitry configured to calculate a membership value for each class of the set of classes in dependence on the class counter values in the joint feature membership table storage when the training phase is complete and to specify a predicted class for each joint feature item in dependence on a largest membership value stored in the joint feature membership table storage for the joint feature item; and
predicted class table storage circuitry configured to store an indication of the predicted class in association with each joint feature item in the joint feature membership table storage.

In examples herein there is provided an apparatus comprising:
multiple feature inputs configured to receive multiple items of feature data for an event, where the multiple items of feature data are representative of a set of measurements taken for the event;
mapping circuitry configured to map each item of feature data to an encoding from a set of encodings, wherein a range of values for each feature input are mapped to the encoding;
concatenation circuitry configured to concatenate multiple encodings corresponding to the multiple items of feature data for the event to generate an event joint feature item;
predicted class table storage circuitry configured to store an indication of a predicted class in association with each joint feature item of a set of joint feature items, wherein the predicted class associated with each joint feature item was previously learned in a training process based on multiple training events with known classes,
wherein in the training process a class counter of a set of class counters corresponding to a known class associated with the training event was incremented for each training event to generate class counter values for each joint feature item generated by the concatenation circuitry in the training phase, and a membership value for each class of the set of classes was determined in dependence on the class counter values when the training process was complete, and predicted classes for the joint feature items were determined in dependence on a largest membership value determined for each joint feature item; and
predicted class output circuitry configured to output the predicted class for the event joint feature item in dependence on the predicted classes stored in the predicted class table storage circuitry.

Accordingly, an apparatus may be provided to make use of class predictions stored in the predicted class table storage, which can be generated according to the methods described above. It should be noted that the class predictions stored in the predicted class table storage may be generated by a dedicated apparatus provided for this purpose or they may be generated by a general-purpose device implementing the above described methods. For example a software based implementation executing in a general-purpose computing device may in some circumstances the preferred manner of generating the class predictions. As a corollary to this the usage of those class predictions stored in the predicted class table storage may be made by a dedicated apparatus provided for this purpose, but could equally be made use of by general-purpose device implementing corresponding methods, which may be supported by corresponding software. In some examples the preferred manner of using the class predictions may be in dedicated hardware implementations, since the present techniques enable these to be provided in a notably “lightweight” manner, i.e. requiring only a modest computing and storage capability, which may be appropriate for various portable and/or long-lifetime contexts where low power consumption is an important factor.

In some examples of the apparatus, the set of encodings is a distance-based set of encodings, wherein a difference between two encodings of the set of encodings reflects a difference between two respective feature regions to which the two encodings correspond. In some examples the set of encodings is a Hamming distance-based set of encodings.

In some examples the predicted class output circuitry is configured to determine the predicted class for the event joint feature item in dependence on a distance between the event joint feature item and each joint feature item of a set of joint feature items, wherein the predicted class is selected from the joint feature item for which the distance is minimised. The distance calculation may be implemented in a variety of ways but in some examples this may be provided by an array of XOR gates followed by a pop count operation subsequently the minimum distance can be found by finding the minimum with an array of comparators.

The present techniques recognise that more than one joint feature item may have a same minimum distance. In some examples, when more than one joint feature item has a same minimum distance, the predicted class is selected from amongst a set of predicted classes for the more than one joint feature item as one of:
a majority class of the set of predicted classes;
a random selection from the set of predicted classes; and
a first class encountered in a predetermined ordering of the set of predicted classes.

In some examples the predicted class table storage circuitry and the predicted class output circuitry are embodied as hard-wired components, wherein the distance between the event joint feature item and each joint feature item of a set of joint feature items is generated by an array of XOR gates followed by popcount circuitry and wherein a minimum distance used to determine the joint feature item for which the distance is minimised is determined by an array of comparators.

As mentioned above the present techniques recognise that when entry coalescing is carried out in the training process, certain bits which differ between entries which have been coalesced may be identified and these bits may then be handled differently in terms of comparisons against future feature data which is received. In particular it is recognised that these bits are of lesser significance, and indeed to the coalesced entries they may be omitted. Thus in some examples at least one entry in the predicted class table storage circuitry is a result of entry coalescing in the training process, wherein coalesced entries had a same predicted class, wherein the predicted class table storage circuitry is further configured to store at least one bit position of at least one bit which differed between the coalesced entries in association with the at least one entry, and wherein in the array of XOR gates no XOR gate is provided at the at least one bit position.

The apparatus may be formed in a great variety of ways, however as mentioned above the present techniques may be of particular benefit to smaller, lighter devices and accordingly in some examples the apparatus is formed as a flexible electronic device. This may for example be a system-on-plastic device.

In some examples there is a method comprising:
receiving multiple items of feature data for an event, where the multiple items of feature data are representative of a set of measurements taken for the event;
mapping each item of feature data to an encoding from a set of encodings, wherein a range of values for each feature input are mapped to the encoding;
concatenating multiple encodings corresponding to the multiple items of feature data for the event to generate an event joint feature item;
storing in predicted class table storage an indication of a predicted class in association with each joint feature item of a set of joint feature items, wherein the predicted class associated with each joint feature item was previously learned in a training process based on multiple training events with known classes,
wherein in the training process a class counter of a set of class counters corresponding to a known class associated with the training event was incremented for each training event to generate class counter values for each joint feature item generated in the training phase, and a membership value for each class of the set of classes was determined in dependence on the class counter values when the training process was complete, and predicted classes for the joint feature items were determined in dependence on a largest membership value determined for each joint feature item; and
outputting the predicted class for the event joint feature item in dependence on the predicted classes stored in the predicted class table storage.

In some examples there is a computer readable storage medium storing computer program instructions, which when executed on a computing device cause the computing device to carry out the above described method.

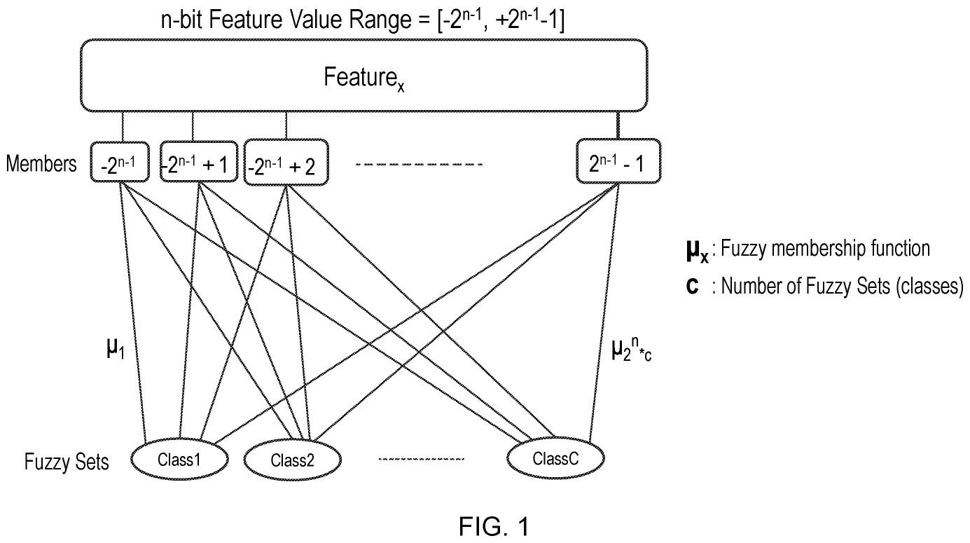

Some particular embodiments are now described with reference to the figures. FIG. 1 schematically illustrates a “fuzzy logic” approach to handling an item of feature data, labelled “Featurex”. Here, in a machine learning (ML) context, each class is considered as a fuzzy set in which all possible values of a feature are the fuzzy set members with some membership degree. All possible values are defined as all integer values in an n-bit integer value of the feature. For example, if the feature is a signed 8-bit integer, then all possible values in the set is within [−128, +127]. Each number within [−128, +127] becomes a member, and its membership value per class or fuzzy set can be calculated. Thus in the generic illustration of FIG. 1, where the feature value range is [−2ⁿ⁻¹, +2ⁿ⁻¹−1], the members are −2ⁿ⁻¹, +2ⁿ⁻¹+1, etc. up to +2ⁿ⁻¹−1. The membership functions are shown as μₓ and there are c fuzzy sets (classes).

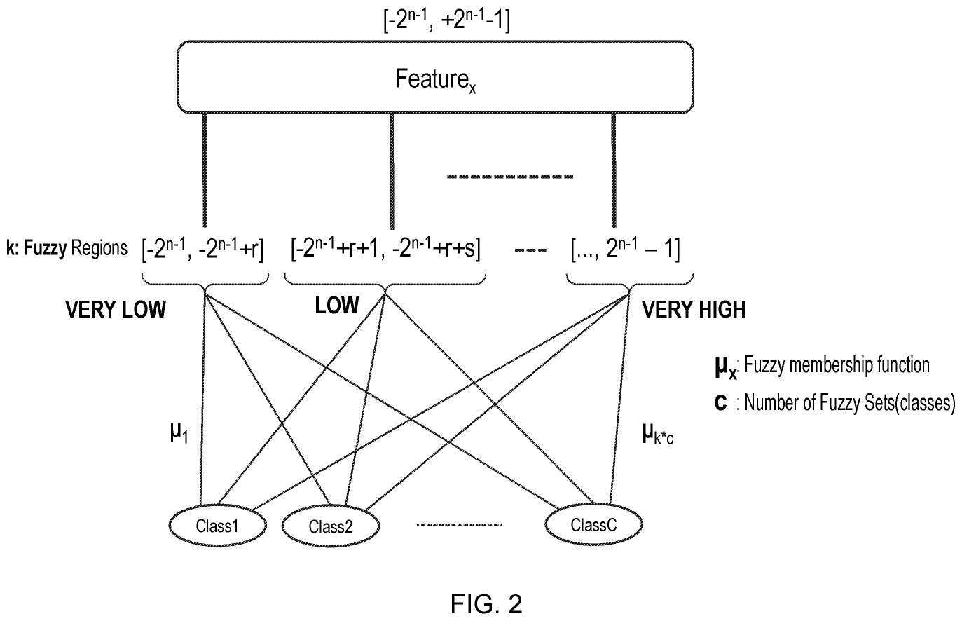

FIG. 2 schematically illustrates the grouping of feature values into regions, where each of those regions are then treated as a member of the set of defined classes. In the generic example shown, the possible values cover the range [−2ⁿ⁻¹, +2ⁿ⁻¹−1], and a first region is defined comprising all feature values in the range [−2ⁿ⁻¹, −2ⁿ⁻¹+r], a second region is defined comprising all feature values in the range [−2ⁿ⁻¹+r+1, −2ⁿ⁻¹+r+s], and so on, up to a last region comprising all feature values in a final group extending up to [+2ⁿ⁻¹−1]. These regions are arbitrarily labelled as “VERY LOW”, “LOW”, etc. up to “VERY HIGH”.

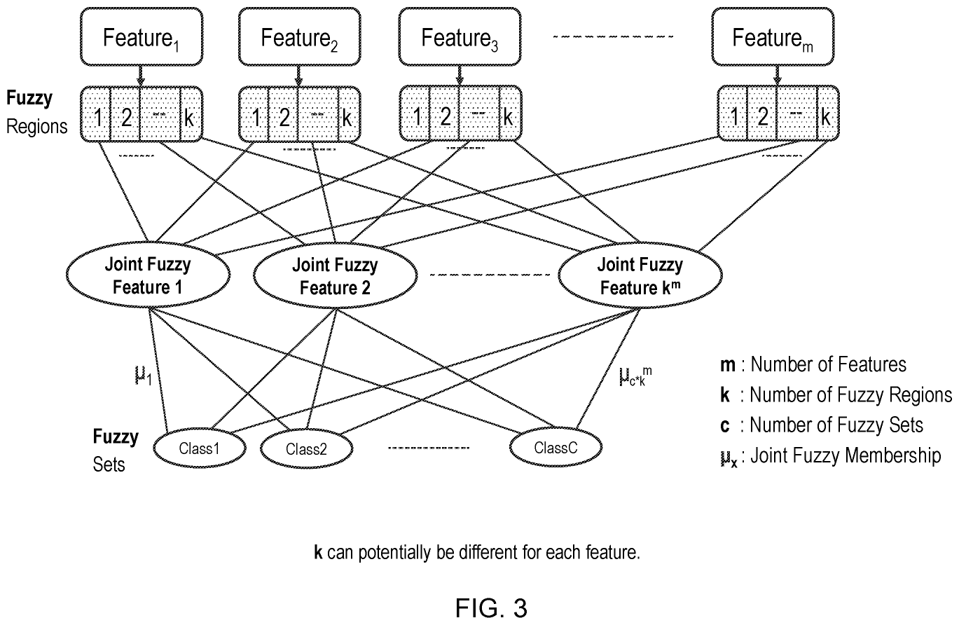

FIG. 3 then extends this concept to the reception of m items of feature data (corresponding to an arbitrary event), labelled as Features to Featureₘ. The feature values are subdivided into k ranges (fuzzy regions) (noting that for simplicity k is shown as being the same for each feature, but can be different or each). The fuzzy regions are represented by predefined encodings, which are concatenated to form a joint feature item (a “joint fuzzy feature”), where the permutations of m items of feature data and k regions produce k^{m} joint fuzzy features. These each have a membership value μ_{c}*k^{m} for each of the c classes.

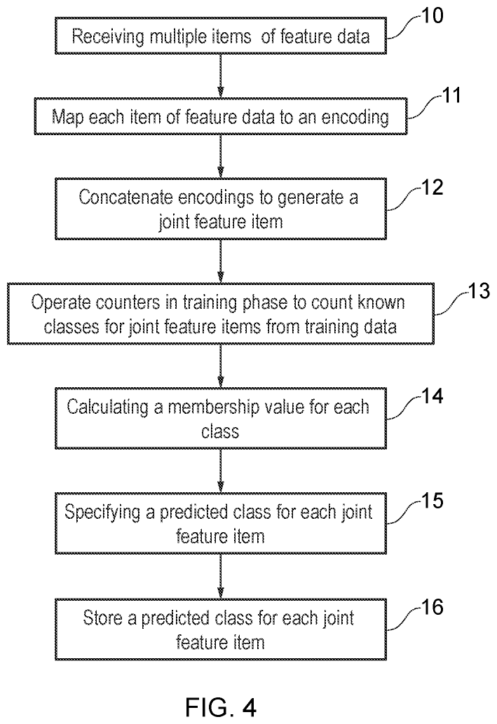

The membership of each joint feature item to each class or fuzzy set can be computed on the basis of training data, where the counts of known classes for events in the training data for joint feature items are accumulated and then used to determine these membership values. Because each feature value is mapped to a fuzzy region, computing the joint memberships is tractable because there are then much fewer fuzzy values or regions. A predicted class can then be determined for each joint feature item and stored as the machine learned classification correspond to that joint feature item. An example method according to some examples disclosed herein of doing this is shown in FIG. 4. This flow begins at step 10, where multiple items of feature data are received. These are then each mapped to an encoding at step 11 and at step 12 the encodings are concatenated to generate a joint feature item. Counters are operated in a training phase to count known classes for joint feature items from training data at step 13 and at step 14 a membership value is calculated for each class. Finally a predicted class for each joint feature item is specified on the basis of the membership values per class at step 15 and a predicted class for each joint feature item is stored at step 16.

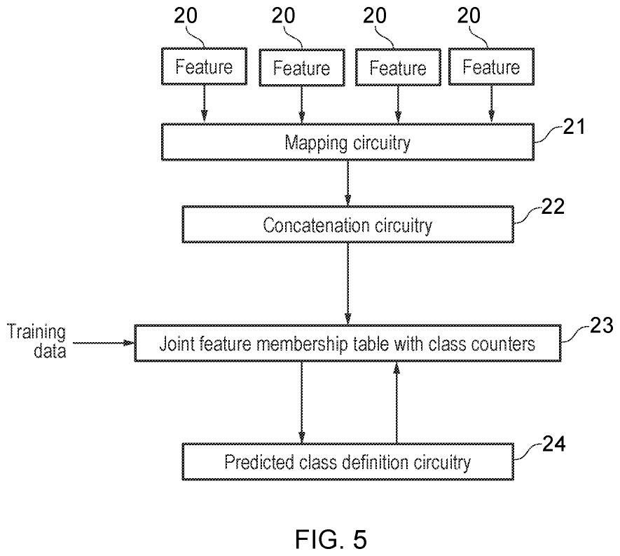

FIG. 4 shows a method flow which is one example of the techniques disclosed herein, and these method steps may for example be implemented by a generic computing device programmed by software to perform those steps. The technique may also be performed by hardware constructed for this purpose and FIG. 5 gives an example of the configuration of such an apparatus, where a set of items of feature data 20 are received by mapping circuitry 21, which maps each to an encoding and these encodings are concatenated by concatenation circuitry 22 to generate a joint feature item. A joint feature membership table 23 comprising class counters is used in a training phase to count known classes for joint feature items from training data. Then predicted class definition circuitry 24 accesses the joint feature membership table and on the basis of the counter values updates the membership values per class and a predicted class for each joint feature item is stored.

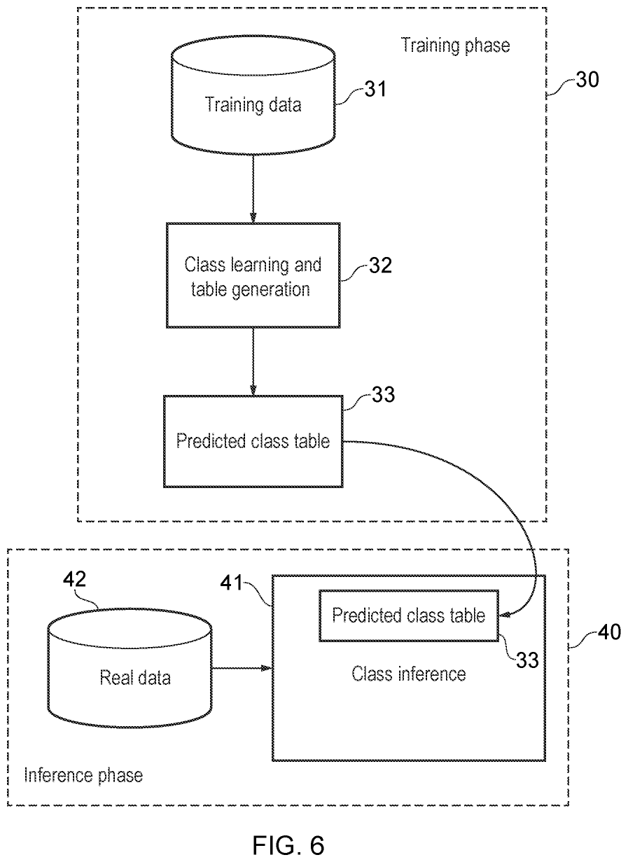

FIG. 6 presents an overview of the present techniques, which broadly speaking may be considered in two parts, namely a training phase 30 and an inference phase 40. The aim of the training phase is to develop a predicted class table 33 on the basis of training data 31 for which the corresponding classes for each set of feature data are known, such that this predicted class table may then be used in an inference phase to infer a class for sets of new (as yet unseen) feature data. A particular aim of the present techniques is to provide the predicted class table in a format which does not require large storage capacity or complex computing capability to use it, such that it may be used, for example, in small, portable devices, indeed also in very lightweight electronics, such as flexible electronics which may be worn. Thus the class learning and table generation 32 of the training phase need not be constrained to performed on such lightweight devices and indeed may typically be carried out on a powerful general purpose computing device programmed for this purpose. Conversely the class inference capability 41 in the inference phase can then be implemented in a lightweight manner, such as dedicated hardware manufactured as a flexible electronic device.

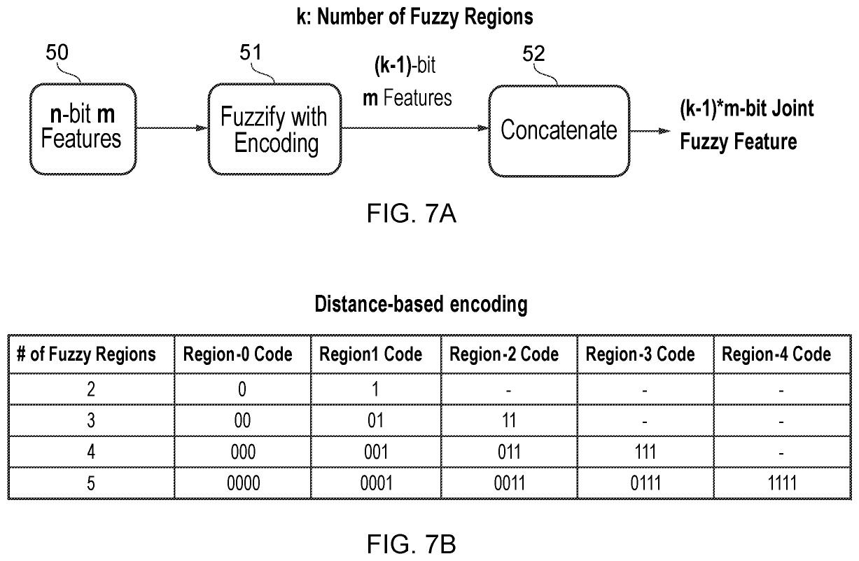

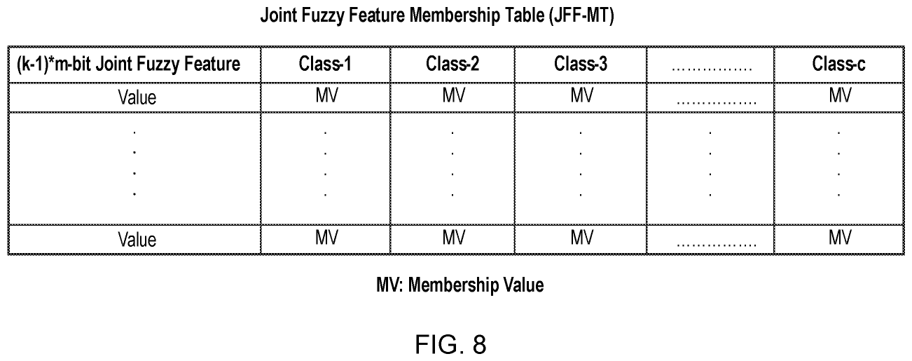

Returning now to the training phase, FIG. 7A schematically shows the generation of a joint fuzzy feature in some examples. A set of m features 50, each being an n-bit value is received and is “fuzzified” 51 by mapping the values of the features into predefined regions of those values, each with a corresponding encoding. This results in m encodings each comprising k−1 bits (where there are k regions). These encodings are concatenated 52 to generate a (k−1)*m bit joint fuzzy feature. An example distance-based encoding is shown in FIG. 7B. For k fuzzy regions, this encoding requires (k−1) bits to represent the k fuzzy regions. After computing the fuzzy region encodings, the joint fuzzy feature is be formed by concatenating the m (k−1)-bit features. The concatenated entries are in this example stored in a table called the “Joint Fuzzy Feature Membership Table” (JFF-MT) as shown in FIG. 8. The encoding chosen for the example of FIG. 7B is a distance-based encoding based on the Hamming distance between the fuzzy regions. Examples are given of the encodings for 2, 3, 4, and 5 regions. Any other encoding could be chosen which distinguishes between the values, but one benefit of the encoding of FIG. 7B is that or any arbitrary fuzzy regions, the distance between the two regions can be found by calculating the Hamming distance. This distance can be employed in the context of the present techniques as a measure of the similarity/difference between two joint fuzzy features.

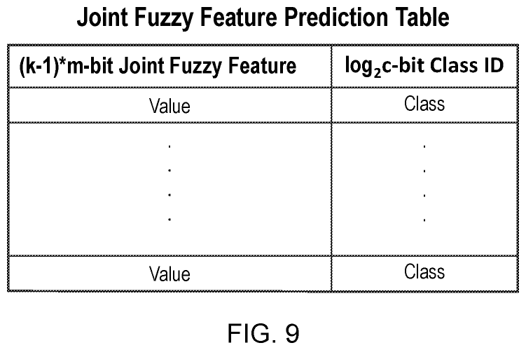

FIG. 8 shows an example of a joint fuzzy membership table (JFF-MT) in some examples. Each joint fuzzy feature is accompanied by c entries each of which defines the joint fuzzy set membership value (MV) for that class. Thus set up, in the training phase all table entries are initialised to zero. Each training data point is converted into a joint fuzzy feature and its true class label is used to identify the class ID in the entry and the counter for that class is incremented. After all training data points are visited, the joint membership values are calculated from the counters, and the class with the maximum membership value is the predicted class for the joint fuzzy feature. FIG. 9 shows an example of a JFF prediction table which has been reduced from the joint fuzzy feature membership table of FIG. 8. Note that the class IDs are stored in log₂ c-bit format.

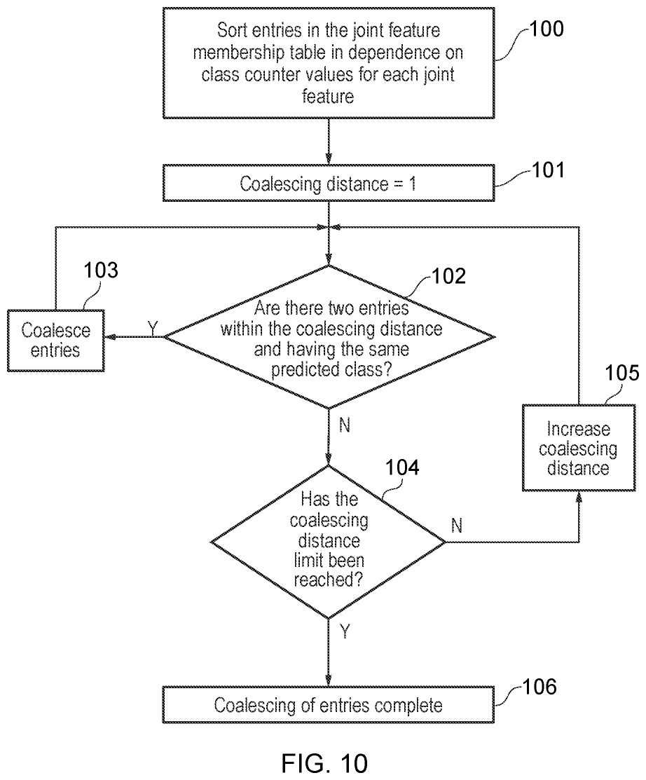

A further aspect of the present techniques allows the reduction of number of entries in the JFF prediction table. The greater the number of table entries, the greater the complexity of any hardwired circuitry which is provided to make use of the table. Thus in order to reduce this complexity, the learning phase can be extended to coalesce table entries with an algorithm. The basic steps of the algorithm are shown in FIG. 10. This algorithm begins at step 100 where the table entries are sorted by the sum of the membership counter values. A coalescing distance is set to 1 at step 101. Then, starting from the top of the list, the process takes an entry and find any affine JFFs with a Hamming distance of 1. If such a pair of JFFs is found, at step 103 the two entries that have the same predicted class are coalesced. The main (larger count value) entry is kept and affine JFF entries are discarded. The membership values from the discarded affine entry are inherited by the main entry, i.e. the inherited joint membership values are accumulated to the joint membership values of the main entry. This continues until the list is exhausted for this coalescing distance. At step 104 it is determined if a predetermined coalescing distance limit has been reached. If it has not then at step 105 the coalescing distance is incremented (e.g. by 1) and the process continues for the new distance. Once the limit is reached the process is complete at step 106.

The determination of the coalescing distance limit is a choice of system design, where this allows a chosen balance between the size of the table and the accuracy of the class prediction to be struck. Thus in an associated process, this design space can be explored to determine the chosen coalescing distance. This exploration of the design space is carried out by only performing one coalescing distance per design point. For example, given a number of fuzzy regions k, there will be d design points where d is the total number of coalescing Hamming distances (from 0 to d−1). The first design point has k fuzzy regions and 0 coalescing Hamming distance. This is also equivalent to the non-reduced or original table. The second design point has k fuzzy regions and 1 coalescing Hamming distance, and so on until the d-th design point is reached where the parameter is (k, d).

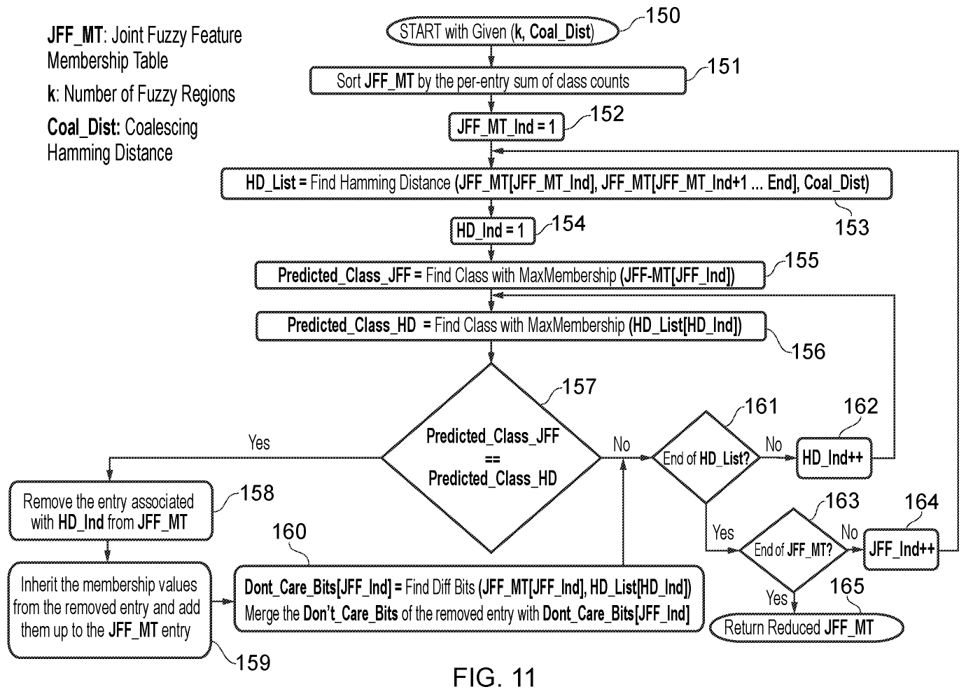

FIG. 11 shows an example algorithm for coalescing the entries of a JFF_MT for a given number of fuzzy regions and a coalescing Hamming distance number. For a given number of fuzzy regions k and a given coalescing distance at step 150, the JFF_MT is sorted by the per-entry sum of class counts at step 151. At step 152 an index JFF_MT_Ind is set to 1. Then at step 153 a Hamming Distance list HD_List is populated by those entries which are within the defined coalescing distance from one another. A Hamming Distance index HD_Ind is set to 1 at step 154. The class with the highest membership count value in the table is determined at step 155, then at step 156 the class with the highest membership count value in the HD_List is determined. At step 157 is determined if these classes are the same. If they are the flow proceeds to step 158 for the two entries to be coalesced. The entry associated with HD_Ind is removed from JFF_MT at step 158 and at step 159 the membership values of the removed inherited entry are accumulated to those of the kept entry.

Then at step 160 a further proposal of the present techniques is implemented in this example, namely the determination of “don't care bits”. These “don't care bits” store the positions of the bits that differ between the main JFF_MT entry and the removed entry when calculating the Hamming distance. These don't care bits are stored for the JFF_MT entry in the algorithm. Then the don't care bits from the removed entry are inherited and merged with the don't care bits of the JFF_MT entry. The don't care bits collected during the learning phase are intended for use in the inference phase. Essentially, the don't care bits indicate that a comparison of these bits is meaningless (for merged entries) because each don't care bit then represents both 0 and 1. The advantage of this is that when the inference hardware is implemented as hardwired, comparators associated with the don't care bits can be eliminated.

Following step 160, or after a negative determination at step 157, at step 161 further processing of the HD_List may be triggered (via step 162, incrementing the index HD_Ind and leading back to step 156) and when this is complete, at step 163 further processing of the JFF_MT may be triggered (via step 164, incrementing the index JFF_MT_Ind and leading back to step 153). Once the full table has been processed the reduced JFF_MT is returned at step 165.

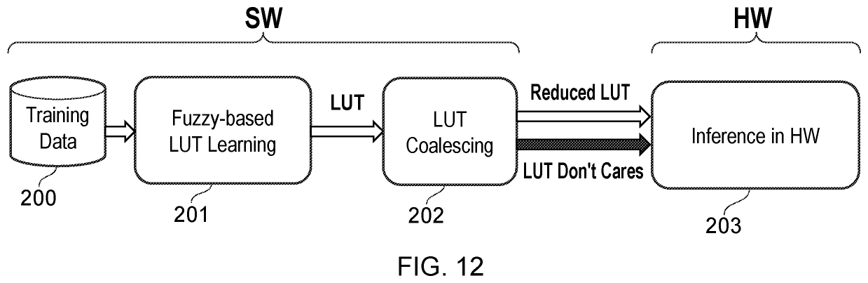

FIG. 12 schematically illustrates an overview of the training and inference phases in some examples, where these are implemented in software and hardware respectively and the above-described table entry coalescing and determination of “don't′ care bits” is carried out, enabling the hardware to be implemented in a very lightweight manner. Training data 200 is used for software-implemented fuzzy-learning-based generation 201 of a class prediction lookup (LUT), which is subjected to coalescing 202 to reduce its size. The reduced size table and the determined don't care bits are then used in the hardware implementation 203, which is thus configured to predict (infer) classes for new data it encounters.

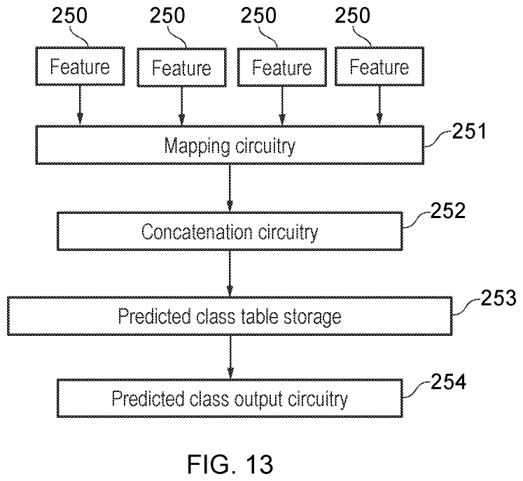

FIG. 13 schematically illustrates an example of the configuration of such a hardware implementation for the inference phase. The apparatus is configured to receive a set of items of feature data 250, each of which are mapped by mapping circuitry 251 to an encoding and these encodings are concatenated by concatenation circuitry 252 to generate a joint feature item. This joint feature item is then compared against the content of a class prediction table 253 by the predicted class output circuitry 254 and on the basis of proximity (in terms, say of Hamming distance) a nearest joint feature entry in the table is selected. If there is an entry with a distance of 0, then that is a direct match and its associated class ID is the predicted class. If there is no entry found with a distance of 0, then the entry or entries that have the next smallest Hamming distance will be found. If there is more than 1, then the predicted class is determined by one of these methods: 1) pick the majority class; 2) pick one randomly; or 3) select one from a predetermined order (e.g. leftmost or rightmost) of the candidates.

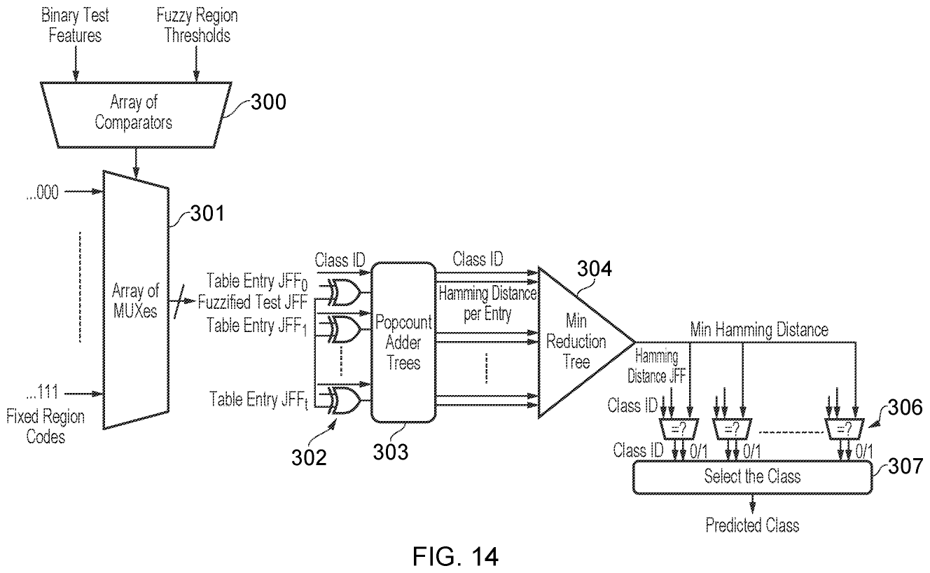

FIG. 14 schematically illustrates more detail of an example hardware implementation for the inference phase. The set of feature data in this example are received as binary test features. Predetermined fuzzy region thresholds are also provided. An array of comparators 300 then maps the feature data into region-based data. This fuzzified region-based data then controls the operation of an array of MUXes 301 which take fixed encodings for the regions and thus output a set of encodings corresponding to the feature data received. The individual bits of these encodings (“fuzzified Test FFF”) then each form one input to a respective XOR gate of an array of XOR gates 302, where the other input (“Table Entry JFFₓ”) is provided by the content of the prediction table, the subsequent popcount adder trees 303 then generate a Hamming distance per entry. The minimum Hamming distance is found by the reduction tree (array of comparators) 304. The minimum Hamming distance value thus found is then compared with each Hamming distance value per entry by the comparators 306 to find the matching entry or entries. Finally, a class selection between the matching entries 307 determines the predicted class. Note that the diagram shows the Class IDs being fed through the processing chain since this facilitates the final step of class ID selection in the class selection circuitry 307 based on the output of the comparators 306. However the class IDs do not play a functional role in the popcount adder trees 303 or the reduction tree (array of comparators) 304.

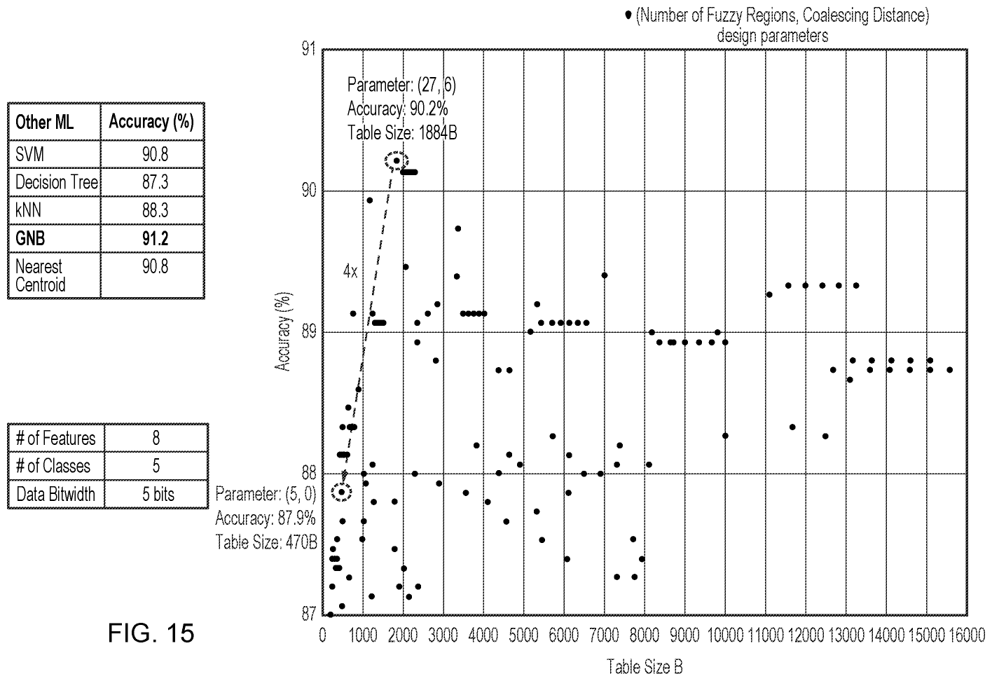

FIGS. 15, 16, and 17 show some results of applying the present techniques to various ML data sets, where the entire design space (of number of fuzzy regions and coalescing distance) is visited to find the best parameter pair, with the aim of keeping the prediction accuracy as high as possible and the table size as low as possible. A first dataset is shown in FIG. 15, which also shows the performance of other conventional ML algorithms such as SVM, Decision Tree, k Nearest Neighbour, Gaussian Naïve Bayes and Nearest Centroid. The best performing design point in terms of prediction accuracy is with (Number of Fuzzy Regions=27, Coalescing Distance=6) at 90.2%, which is one percentage point smaller than GNB that has the highest performance among the classical ML algorithms with 91.2%. The table size for this design point is around 1.8 kB. If another percentage point can be sacrificed in performance, it is possible to reduce the table size by 60% to 0.7 kB.

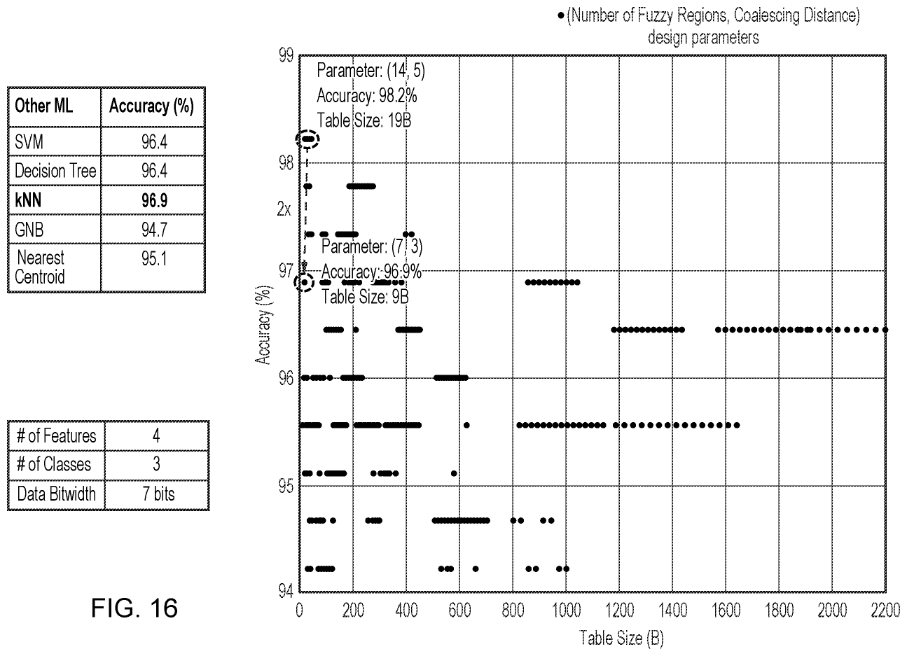

FIG. 16 shows the results for a second dataset. Here, the fuzzy-based present techniques algorithm performs better than all the conventional ML algorithms. The design parameter (Number of Fuzzy Regions=14, Coalescing Distance=5) reaches 98.2% prediction accuracy using only 19B in the table. An interesting design point is with (7,3) at 96.9%, which is on par with the performance of the best conventional ML algorithm and needs only 9B in the table.

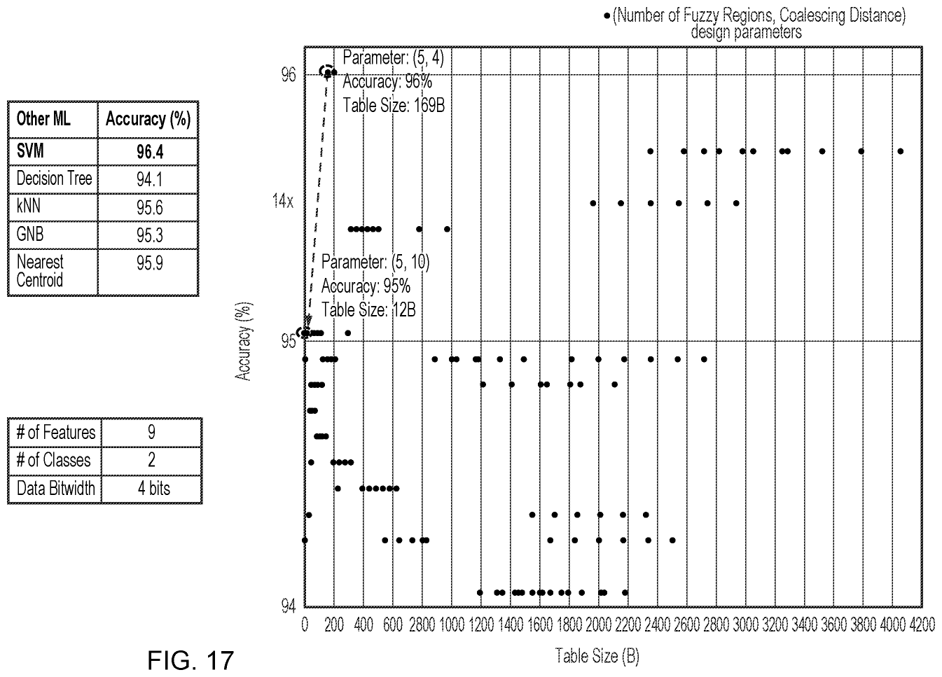

FIG. 17 shows the results for a third dataset. The highest prediction accuracy is 96% with the design parameters of (5,4) and uses a table size of 169B. The performance of the fuzzy-inspired ML model is on par with the best performing conventional ML model, which is SVM with 96.4% accuracy. If 95% accuracy is acceptable, then the table size can be reduced by 14× to 12B with the parameter of (5,10).

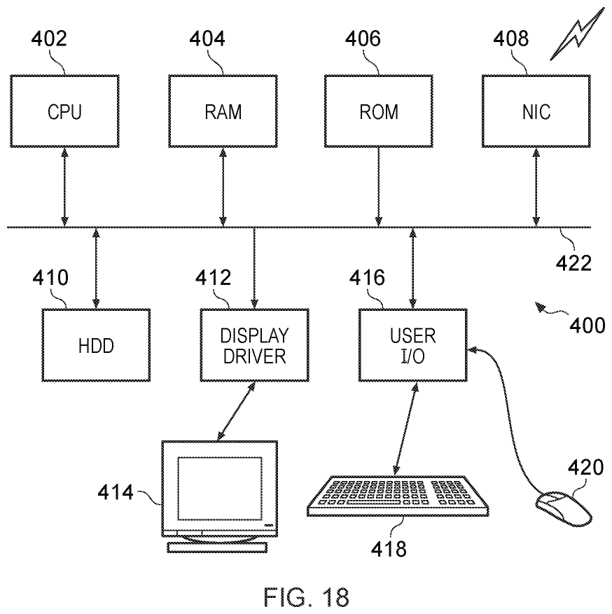

FIG. 18 schematically illustrates a general purpose computer 400 of the type that may be used to implement the above described techniques, in particular in the learning phase. The general purpose computer 400 includes a central processing unit 402, a random access memory 404, a read only memory 406, a network interface card 408, a hard disk drive 410, a display driver 412 and monitor 414 and a user input/output circuit 416 with a keyboard 418 and mouse 420 all connected via a common bus 422. In operation the central processing unit 402 will execute computer program instructions that may be stored in one or more of the random access memory 404, the read only memory 406 and the hard disk drive 410 or dynamically downloaded via the network interface card 408. The results of the processing performed may be displayed to a user via the display driver 412 and the monitor 414. User inputs for controlling the operation of the general purpose computer 400 may be received via the user input output circuit 416 from the keyboard 418 or the mouse 420. It will be appreciated that the computer program could be written in a variety of different computer languages. The computer program may be stored and distributed on a recording medium or dynamically downloaded to the general purpose computer 400. When operating under control of an appropriate computer program, the general purpose computer 400 can perform the above described techniques and can be considered to form an apparatus in particular for performing the above described learning phase techniques. The architecture of the general purpose computer 400 could vary considerably and FIG. 18 is only one example.

Alternatively, the above-described techniques may be implemented in a more distributed fashion, wherein the general purpose computer 400 illustrated in FIG. 18 may be expanded and/or replaced by an infrastructure comprising components implemented on separate physical devices, the separate physical devices sharing the processing required to carry out these techniques. Such separate physical devices may be physically proximate to one another, or may even be located at entirely different physical locations. In some configurations such an infrastructure is termed a ‘cloud computing’ arrangement.

In brief overall summary, apparatuses and methods for supporting class prediction based on multiple items of feature data are provided. In a learning phase training data with known classification are used as inputs and for each event of the training data multiple items of feature data are mapped to encodings, where a range of values for each feature input are mapped to a given encoding. The concatenated encoding for the event forms a joint feature item and class counters are used to count class known to associated with the training event for the joint feature item in a table. At the conclusion of the training phase the class counter values enable a predicted class to be associated with each joint feature item in the table. In a subsequent inference phase the table is used for class prediction generation for new data events. The inference phase may be implemented in hardware which has significantly less data handling capability than was employed in the learning phase.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Various configurations disclosed herein are summarized in the following numbered clauses:

Clause 1. A method comprising:
receiving multiple items of feature data for an event, where the multiple items of feature data are representative of a set of measurements taken for the event;
mapping each item of feature data to an encoding from a set of encodings, wherein a range of values for each feature input are mapped to the encoding;
concatenating multiple encodings corresponding to the multiple items of feature data for the event to generate a joint feature item;
operating a set of class counters, wherein each class counter corresponds to a class of a set of classes to which events can be assigned, and in response to the joint feature item generated in a training phase incrementing a class counter of the set of class counters corresponding to a known class associated with the event;
storing class counter values in joint feature membership table storage for each joint feature item generated in the training phase in which the multiple items of feature data are received for multiple training events;
calculating a membership value for each class of the set of classes in dependence on the class counter values in the joint feature membership table storage when the training phase is complete;
specifying a predicted class for each joint feature item in dependence on a largest membership value stored in the joint feature membership table storage for the joint feature item; and
storing in predicted class table storage an indication of the predicted class in association with each joint feature item in the joint feature membership table storage.
   Clause 2. The method as defined in clause 1, wherein the set of encodings is a distance-based set of encodings, wherein a difference between two encodings of the set of encodings reflects a difference between two respective feature regions to which the two encodings correspond.
   Clause 3. The method as defined in clause 2, wherein the set of encodings is a Hamming distance-based set of encodings.
   Clause 4. The method as defined in clause 2 or clause 3, further comprising performing an entry coalescing process comprising sorting entries in the joint feature membership table storage in dependence on a sum of the class counter values for each joint feature item and coalescing entries which have a same predicted class in dependence on the difference between their encodings.
   Clause 5. The method as defined in clause 4, wherein coalescing the entries comprises retaining a dominant entry with a larger sum of the class counter values, discarding one or more recessive entries with a smaller sum of the class counter values, and transferring the class counter values from the one or more recessive entries to the dominant entry.
   Clause 6. The method as defined in clause 4 or clause 5, wherein the entry coalescing process is performed as an encoding-distance limited process according to which the entry coalescing process is performed for differences between encodings which differ by up to a predetermined encoding distance threshold.
   Clause 7. The method as defined in clause 6, wherein the predetermined encoding distance threshold is determined prior to the method being performed by a parameter exploration process, which tests the entry coalescing process for all possible differences between encodings.
   Clause 8. The method as defined in clause 7, wherein the predetermined encoding distance threshold is selected as a result of the parameter exploration process dependent on a resulting size of the joint feature membership table storage and a corresponding accuracy of the predicted class.
   Clause 9. The method as defined in any of clauses 5-8, further comprising determining at least one bit position of bits which differ between the dominant entry and the one or more recessive entries and storing the at least one bit position in association with the dominant entry in the joint feature membership table storage, wherein any positions previously stored in association with the one or more recessive entries are transferred to the dominant entry.
   Clause 10. A computer readable storage medium storing computer program instructions, which when executed on a computing device cause the computing device to carry out the method of any of clauses 1-9.
   Clause 11. Apparatus comprising:
multiple feature inputs configured to receive multiple items of feature data for an event, where the multiple items of feature data are representative of a set of measurements taken for the event;
mapping circuitry configured to map each item of feature data to an encoding from a set of encodings, wherein a range of values for each feature input are mapped to the encoding;
concatenation circuitry configured to concatenate multiple encodings corresponding to the multiple items of feature data for the event to generate a joint feature item;
class counter circuitry comprising a set of class counters, wherein each class counter corresponds to a class of a set of classes to which events can be assigned, and wherein the class counter circuitry is responsive to the joint feature item generated by the concatenation circuitry in a training phase to increment a class counter of the set of class counters corresponding to a known class associated with the event;
joint feature membership table storage configured to store class counter values for each joint feature item generated by the concatenation circuitry in the training phase in which the multiple feature inputs are configured to receive the multiple items of feature data for multiple training events;
predicted class definition circuitry configured to calculate a membership value for each class of the set of classes in dependence on the class counter values in the joint feature membership table storage when the training phase is complete and to specify a predicted class for each joint feature item in dependence on a largest membership value stored in the joint feature membership table storage for the joint feature item; and
predicted class table storage circuitry configured to store an indication of the predicted class in association with each joint feature item in the joint feature membership table storage.
   Clause 12. Apparatus comprising:
multiple feature inputs configured to receive multiple items of feature data for an event, where the multiple items of feature data are representative of a set of measurements taken for the event;
mapping circuitry configured to map each item of feature data to an encoding from a set of encodings, wherein a range of values for each feature input are mapped to the encoding;
concatenation circuitry configured to concatenate multiple encodings corresponding to the multiple items of feature data for the event to generate an event joint feature item;
predicted class table storage circuitry configured to store an indication of a predicted class in association with each joint feature item of a set of joint feature items, wherein the predicted class associated with each joint feature item was previously learned in a training process based on multiple training events with known classes,
wherein in the training process a class counter of a set of class counters corresponding to a known class associated with the training event was incremented for each training event to generate class counter values for each joint feature item generated by the concatenation circuitry in the training phase, and a membership value for each class of the set of classes was determined in dependence on the class counter values when the training process was complete, and predicted classes for the joint feature items were determined in dependence on a largest membership value determined for each joint feature item; and
predicted class output circuitry configured to output the predicted class for the event joint feature item in dependence on the predicted classes stored in the predicted class table storage circuitry.
   Clause 13. The apparatus as defined in clause 12, wherein the set of encodings is a distance-based set of encodings, wherein a difference between two encodings of the set of encodings reflects a difference between two respective feature regions to which the two encodings correspond.
   Clause 14. The apparatus as defined in clause 13, wherein the set of encodings is a Hamming distance-based set of encodings.
   Clause 15. The apparatus as defined in clause 13 or clause 14, wherein the predicted class output circuitry is configured to determine the predicted class for the event joint feature item in dependence on a distance between the event joint feature item and each joint feature item of a set of joint feature items, wherein the predicted class is selected from the joint feature item for which the distance is minimised.
   Clause 16. The apparatus as defined in clause 15, wherein when more than one joint feature item has a same minimum distance, the predicted class is selected from amongst a set of predicted classes for the more than one joint feature item as one of:
a majority class of the set of predicted classes;
a random selection from the set of predicted classes; and
a first class encountered in a predetermined ordering of the set of predicted classes.
   Clause 17. The apparatus as defined in clause 15 or 16, wherein the predicted class table storage circuitry and the predicted class output circuitry are embodied as hard-wired components, wherein the distance between the event joint feature item and each joint feature item of a set of joint feature items is generated by an array of XOR gates followed by popcount circuitry and wherein a minimum distance used to determine the joint feature item for which the distance is minimised is determined by an array of comparators.
   Clause 18. The apparatus as defined in clause 17, wherein at least one entry in the predicted class table storage circuitry is a result of entry coalescing in the training process, wherein coalesced entries had a same predicted class, wherein the predicted class table storage circuitry is further configured to store at least one bit position of at least one bit which differed between the coalesced entries in association with the at least one entry, and wherein in the array of XOR gates no XOR gate is provided at the at least one bit position.
   Clause 19. The apparatus of any of clauses 10-16, wherein the apparatus is formed as a flexible electronic device.
   Clause 20. A method comprising:
receiving multiple items of feature data for an event, where the multiple items of feature data are representative of a set of measurements taken for the event;
mapping each item of feature data to an encoding from a set of encodings, wherein a range of values for each feature input are mapped to the encoding;
concatenating multiple encodings corresponding to the multiple items of feature data for the event to generate an event joint feature item;
storing in predicted class table storage an indication of a predicted class in association with each joint feature item of a set of joint feature items, wherein the predicted class associated with each joint feature item was previously learned in a training process based on multiple training events with known classes,
wherein in the training process a class counter of a set of class counters corresponding to a known class associated with the training event was incremented for each training event to generate class counter values for each joint feature item generated in the training phase, and a membership value for each class of the set of classes was determined in dependence on the class counter values when the training process was complete, and predicted classes for the joint feature items were determined in dependence on a largest membership value determined for each joint feature item; and
outputting the predicted class for the event joint feature item in dependence on the predicted classes stored in the predicted class table storage.
   Clause 21. A computer readable storage medium storing computer program instructions, which when executed on a computing device cause the computing device to carry out the method of clause 20.

Although illustrative embodiments have been described in detail herein with reference to the accompanying drawings, it is to be understood that the invention is not limited to those precise embodiments, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

1. A method comprising:
receiving multiple items of feature data for an event, where the multiple items of feature data are representative of a set of measurements taken for the event;
mapping each item of feature data to an encoding from a set of encodings, wherein a range of values for each item of feature data are mapped to the encoding;
concatenating multiple encodings corresponding to the multiple items of feature data for the event to generate a joint feature item;
operating a set of class counters, wherein each class counter corresponds to a class of a set of classes to which events can be assigned, and in response to the joint feature item generated in a training phase incrementing a class counter of the set of class counters corresponding to a known class associated with the event;
storing class counter values in joint feature membership table storage for each joint feature item generated in the training phase in which the multiple items of feature data are received for multiple training events;
calculating a membership value for each class of the set of classes in dependence on the class counter values in the joint feature membership table storage when the training phase is complete;
specifying a predicted class for each joint feature item in dependence on a largest membership value stored in the joint feature membership table storage for the joint feature item; and
storing in predicted class table storage an indication of the predicted class in association with each joint feature item in the joint feature membership table storage.

2. The method as claimed in claim 1, wherein the set of encodings is a distance-based set of encodings, wherein a difference between two encodings of the set of encodings reflects a difference between two respective feature regions to which the two encodings correspond.

3. The method as claimed in claim 2, wherein the set of encodings is a Hamming distance-based set of encodings.

4. The method as claimed in claim 2, further comprising performing an entry coalescing process comprising sorting entries in the joint feature membership table storage in dependence on a sum of the class counter values for each joint feature item and coalescing entries which have a same predicted class in dependence on the difference between their encodings.

5. The method as claimed in claim 4, wherein coalescing the entries comprises retaining a dominant entry with a larger sum of the class counter values, discarding one or more recessive entries with a smaller sum of the class counter values, and transferring the class counter values from the one or more recessive entries to the dominant entry.

6. The method as claimed in claim 4, wherein the entry coalescing process is performed as an encoding-distance limited process according to which the entry coalescing process is performed for differences between encodings which differ by up to a predetermined encoding distance threshold.

7. The method as claimed in claim 6, wherein the predetermined encoding distance threshold is determined prior to the method being performed by a parameter exploration process, which tests the entry coalescing process for all possible differences between encodings.

8. The method as claimed in claim 7, wherein the predetermined encoding distance threshold is selected as a result of the parameter exploration process dependent on a resulting size of the joint feature membership table storage and a corresponding accuracy of the predicted class.

9. The method as claimed in claim 5, further comprising determining at least one bit position of bits which differ between the dominant entry and the one or more recessive entries and storing the at least one bit position in association with the dominant entry in the joint feature membership table storage, wherein any positions previously stored in association with the one or more recessive entries are transferred to the dominant entry.

10. A non-transitory computer readable storage medium storing computer program instructions, which when executed on a computing device cause the computing device to carry out the method of claim 1.

11. Apparatus comprising:
multiple feature inputs configured to receive multiple items of feature data for an event, where the multiple items of feature data are representative of a set of measurements taken for the event;
mapping circuitry configured to map each item of feature data to an encoding from a set of encodings, wherein a range of values for each item of feature data are mapped to the encoding;
concatenation circuitry configured to concatenate multiple encodings corresponding to the multiple items of feature data for the event to generate a joint feature item;
class counter circuitry comprising a set of class counters, wherein each class counter corresponds to a class of a set of classes to which events can be assigned, and wherein the class counter circuitry is responsive to the joint feature item generated by the concatenation circuitry in a training phase to increment a class counter of the set of class counters corresponding to a known class associated with the event;
joint feature membership table storage configured to store class counter values for each joint feature item generated by the concatenation circuitry in the training phase in which the multiple feature inputs are configured to receive the multiple items of feature data for multiple training events;
predicted class definition circuitry configured to calculate a membership value for each class of the set of classes in dependence on the class counter values in the joint feature membership table storage when the training phase is complete and to specify a predicted class for each joint feature item in dependence on a largest membership value stored in the joint feature membership table storage for the joint feature item; and
predicted class table storage circuitry configured to store an indication of the predicted class in association with each joint feature item in the joint feature membership table storage.

12. Apparatus comprising:
multiple feature inputs configured to receive multiple items of feature data for an event, where the multiple items of feature data are representative of a set of measurements taken for the event;
mapping circuitry configured to map each item of feature data to an encoding from a set of encodings, wherein a range of values for each item of feature data are mapped to the encoding;
concatenation circuitry configured to concatenate multiple encodings corresponding to the multiple items of feature data for the event to generate an event joint feature item;
predicted class table storage circuitry configured to store an indication of a predicted class in association with each joint feature item of a set of joint feature items, wherein the predicted class associated with each joint feature item was previously learned in a training process based on multiple training events with known classes,
wherein in the training process a class counter of a set of class counters corresponding to a known class associated with the training event was incremented for each training event to generate class counter values for each joint feature item generated by the concatenation circuitry in the training phase, and a membership value for each class of the set of classes was determined in dependence on the class counter values when the training process was complete, and predicted classes for the joint feature items were determined in dependence on a largest membership value determined for each joint feature item; and
predicted class output circuitry configured to output the predicted class for the event joint feature item in dependence on the predicted classes stored in the predicted class table storage circuitry.

13. The apparatus as claimed in claim 12, wherein the set of encodings is a distance-based set of encodings, wherein a difference between two encodings of the set of encodings reflects a difference between two respective feature regions to which the two encodings correspond.

14. The apparatus as claimed in claim 13, wherein the predicted class output circuitry is configured to determine the predicted class for the event joint feature item in dependence on a distance between the event joint feature item and each joint feature item of a set of joint feature items, wherein the predicted class is selected from the joint feature item for which the distance is minimised.

15. The apparatus as claimed in claim 14, wherein when more than one joint feature item has a same minimum distance, the predicted class is selected from amongst a set of predicted classes for the more than one joint feature item as one of:
a majority class of the set of predicted classes;
a random selection from the set of predicted classes; and
a first class encountered in a predetermined ordering of the set of predicted classes.

16. The apparatus as claimed in claim 14, wherein the predicted class table storage circuitry and the predicted class output circuitry are embodied as hard-wired components, wherein the distance between the event joint feature item and each joint feature item of a set of joint feature items is generated by an array of XOR gates followed by popcount circuitry and wherein a minimum distance used to determine the joint feature item for which the distance is minimised is determined by an array of comparators.

17. The apparatus as claimed in claim 16, wherein at least one entry in the predicted class table storage circuitry is a result of entry coalescing in the training process, wherein coalesced entries had a same predicted class, wherein the predicted class table storage circuitry is further configured to store at least one bit position of at least one bit which differed between the coalesced entries in association with the at least one entry, and wherein in the array of XOR gates no XOR gate is provided at the at least one bit position.

18. The apparatus of as claimed in claim 10, wherein the apparatus is formed as a flexible electronic device.

19. A method comprising:
receiving multiple items of feature data for an event, where the multiple items of feature data are representative of a set of measurements taken for the event;
mapping each item of feature data to an encoding from a set of encodings, wherein a range of values for each item of feature data are mapped to the encoding;
concatenating multiple encodings corresponding to the multiple items of feature data for the event to generate an event joint feature item;
storing in predicted class table storage an indication of a predicted class in association with each joint feature item of a set of joint feature items, wherein the predicted class associated with each joint feature item was previously learned in a training process based on multiple training events with known classes,
wherein in the training process a class counter of a set of class counters corresponding to a known class associated with the training event was incremented for each training event to generate class counter values for each joint feature item generated in the training phase, and a membership value for each class of the set of classes was determined in dependence on the class counter values when the training process was complete, and predicted classes for the joint feature items were determined in dependence on a largest membership value determined for each joint feature item; and outputting the predicted class for the event joint feature item in dependence on the predicted classes stored in the predicted class table storage.

20. A non-transitory computer readable storage medium storing computer program instructions, which when executed on a computing device cause the computing device to carry out the method of claim 19.
